(19) United States
(12) Patent Application Publication
(10) Pub. No.: US 2010/0150658 A1
(43) Pub. Date: Jun. 17, 2010

(54) SYSTEM AND METHOD FOR TREATING OIL-BEARING MEDIA

(75) Inventors: Louis BILHETE, Edmonton (CA); Clinton BILHETE, Edmonton (CA); Guoxing GU, Edmonton (CA)

Correspondence Address: EDWARD YOO C/O BENNETT JONES, 3200 TELUS HOUSE, SOUTH TOWER, 10020 - 100 STREET, EDMONTON, ALBERTA, AB, T5J 0N3, CA

(73) Assignee: LCG THERMALPRO INTERNATIONAL INC., Edmonton (CA)

(21) Appl. No.: 12/554,499

(22) Filed: Sep. 4, 2009

Related U.S. Application Data
(60) Provisional application No. 61/094,190, filed on Sep. 4, 2008.

(30) Foreign Application Priority Data
Mar. 24, 2008 (CA) 2660106

(51) Int. Cl. B09C 1/00; F23G 5/027; F23G 7/14; F25J 1/00

(52) U.S. Cl. 405/128.15; 110/236; 110/229; 62/606

(57) ABSTRACT

A process and system for oil-contaminated soil remediation and oil recovery from oil-bearing media such as oil-contaminated soil, different types of oil-bearing sludge's from oil producers, upgraders and refineries, oil shale, oil sands, and coal oil shale, oil sands and coal includes (1) a portable or fixed twin thermal desorption unit with two rotating trundles in one stationary house, and (2) multiple co-combustion burners burning coal, scrap tires, used oils, sludge's containing high oil content, propane and natural gas to supply heat for the twin desorption unit, and (3) a suction fan to create a slightly vacuum environment, receive vapors and send them to (4) a cooling line with a heavy component condenser to condense heavy oils, a set of air cooling pipe to condense light oils and steam and a three-phase (gas/oil/water) separation tank to separate oil from water, and (5) a feeding line with a blender to break wet lumps and a crasher to break rocks presence in the raw material being processed.

### CROSS REFERENCE TO RELATED APPLICATIONS

This application claims the priority benefit of U.S. Provisional Patent Application 61/094,190 filed Sep. 4, 2008 entitled “System and Method for Treating Oil-Bearing Solids”, and Canadian Patent Application 2,660,106 filed Mar. 24, 2009 entitled “System and Method for Treating Oil-Bearing Media”, the contents of which are incorporated herein by reference.

### FIELD OF THE INVENTION

The invention relates to a process and system for treating oil-bearing media such as oil-contaminated soil, oil shale, oil sands, coal, and oil-bearing sludges of different types from oil producers, upgraders and refineries, in order to remediate the media or recover the oil.

### BACKGROUND

Both low temperature thermal desorption (temperature ranging from 90 to 316° C.) and high temperature thermal desorption (temperature ranging from 316 to 427° C.) methods are commonly used to remove volatile and semi-volatile organics from a matrix material. These techniques are typically not effective in removing high boiling point organics such as coal tars or asphalt.

In contrast, pyrolysis (temperature greater than 430° C.) is a chemical decomposition of organic materials induced by heat in an inert environment and may be effective to remove high boiling point organics.

There are numerous examples in the prior art of thermal desorption systems that employ rotary dryers or kilns, high temperature belt conveyors and screw conveyors. Some of these systems also demonstrate both direct and indirect methods of heat transfer. Process conditions for these systems vary widely, with some utilizing vacuum to near atmospheric pressures for separating organic contaminants. All these methods use high cost fuels or energy, such as electricity, natural gas or oils, the cost of which appears to be rising long term.

For remediation of oil-contaminated soils, direct thermal process or incineration process is not a good option as some metals can be emitted to the air as pollutants at high temperature operation. In addition, the soils are sterilized completely and are not suitable for future cultivation.

Therefore, there is a need in the art for a system and method that permits thermal desorption of oil-bearing media, which may mitigate the difficulties of the prior art.

### SUMMARY OF THE INVENTION

The present invention comprises a thermal treatment system and method which permits the flexibility to allow for the practice of low temperature thermal desorption, high temperature thermal desorption or pyrolysis, depending on the contaminated media or oil-bearing media to be treated, while operating with overall energy efficiency.

The system and method of the present invention may be used for oil production from oil shale, oil sands and coal. In one embodiment, it is possible to produce oil from oil shale, oil sands or coal without using water as an extraction solvent, both as a surface separation technology, or in situ.

The system and method may be used to remove organic and inorganic contaminants from solid media such as drill cuttings, tank bottoms or contaminated soils, using low temperature thermal desorption, high temperature thermal desorption or pyrolysis.

Therefore, in one aspect, the invention comprises a thermal remediation or oil production system for treating hydrocarbon bearing media, comprising:
(a) a thermal desorption unit comprising:
   (i) a housing;
   (ii) at least one rotating trundle disposed within the housing;
   (iii) at least one divider dividing the desorption unit into two or more temperature zones along its length such that the temperature of each temperature zone can be heated to temperatures sufficient to volatilize at least a portion of one or more of the hydrocarbons;
   (iv) a feed line to feed the hydrocarbon bearing media into the at least one trundle;
   (v) a suction fan to pull out volatilized hydrocarbons and create a slightly vacuum environment in the at least one trundle;
   (vi) a solids discharge outlet for discharging treated solid media from the at least one trundle;
(b) at least one burner operatively connected to the desorption unit to supply hot exhaust gas within the housing; and
(c) a condenser for condensing at least a portion of volatilized hydrocarbons pulled out of the at least one trundle.
   In one embodiment, the thermal desorption unit comprises at least two trundles, which are termed twin trundles herein.

In another aspect, the invention comprises a co-combustion burner for use with a thermal desorption system, said burner comprising:
(a) a burner box having a fuel inlet, an air inlet, a vaporization chamber, an igniter and a gas outlet for gas oils, wherein fuels are partially combusted in the burner box to create gas oils;
(b) a turbo chamber connected to the gas outlet of the burner box and comprising an external tube and an internal tube concentrically disposed within the external tube, wherein the gas outlet streams gas oils into the internal tube, and said turbo chamber comprises an air inlet feeding both the external tube and internal tube;
(c) a combustion chamber which receives the gas oil air mixture from the turbo chamber, said combustion chamber having an igniter and a hot exhaust gas outlet.

In another aspect, the invention comprises a condensing system for condensing a mixture of volatile hydrocarbons, said system comprising:
(a) a heavy component condenser comprises gas inlet line and a condensing bowl, wherein the gas inlet line is aimed at the condensing bowl, wherein gas velocity in the gas inlet line results in increased pressure at the surface of the condensing bowl.
(b) a light component condenser comprising a plurality of vertical or inclined condensing pipes, wherein said condensing pipes are linked in a serpentine manner, and a collection pipe connected to a lower end of each condensing pipe; and
(c) a three phase separator for receiving uncondensed gas from the condensing pipes, and condensate from the collection pipe, said three phase separator having an upper gas outlet, a middle oil outlet, and a lower water outlet.

### BRIEF DESCRIPTION OF THE DRAWINGS

In the drawings, like elements are assigned like reference numerals. The drawings are not necessarily to scale, with the emphasis instead placed upon the principles of the present invention. Additionally, each of the embodiments depicted are but one of a number of possible arrangements utilizing the fundamental concepts of the present invention. The drawings are briefly described as follows:

FIG. 1 is a schematic flow diagram of the process and system of the present invention, using a twin thermal desorption unit and multiple co-combustion burners along with the gas (propane or natural gas) and used oil feeding lines, heavy and light component condensations and tail gas recycle line.

FIG. 2 is a schematic drawing of the blender, showing an axis with multiple paddles attached to the axis in a tube enclosure, a hopper attached to the enclosure, multiple air inlets on the enclosure at the hopper side.

FIG. 3 is a top plan view of the twin desorption unit, showing two rotating trundles in a stationary house, a twin feeding hopper and a treated material discharging line.

FIG. 4 is a zoom in view of the twin desorption unit, showing some details of the desorption unit;

FIG. 5 is a feeding side sectional view of the twin desorption unit; showing means for rotating the trundles and withdrawing the vapors.

FIG. 6 is a cross A-A′ sectional view of the twin desorption unit, showing the stationary house internal details.

FIG. 7 is a schematic view of the heavy oil condenser, showing a cooling tank with a vapor inlet in the middle, a vapor outlet at the top, an oil outlet at the lower part, an oily sludge outlet at the bottom, a cone-shaped or parabola-shaped metal dish mounted on a dish holder inside the cooling tank, a handle to adjust the dish position.

FIG. 8 is a schematic view of the light component condenser and the three-phase (gas/oil/water) separation tank, showing a set of air cooling pipes vertically arranged to condense light gas oils and steam, and the three-phase separation tank to separate tail gas, light oils and water.

FIG. 9 is a side view of the co-combustion burner, showing burner box, turbo and combustion chambers along with air controls and ignition boxes.

FIG. 10 is a schematic view of the turbo and combustion chambers, showing details of the turbo and combustion chambers, a sectional top view of the gas oils-air mixing, a cross section view of the fins that enhance turbulent flow, and air flow rate control.

FIG. 11 is a top plan view of the co-combustion burner, showing burner box, turbo and combustion chambers, ignition boxes along with the configuration of the gas oil (smoke) channels in the middle of the left and front sides.

FIG. 12 is a front and sectional top views of the burner box, showing the center concrete support holding the screen that divides the burner box into volatilizing and ash rooms, and the center air supply line.

FIG. 13 is a front and back views of the burner box, showing the volatilizing and ash rooms, air and gas oil channels, door for ash removal, location of the used oil inlet, lid for loading solids fuels and maintenance.

### DETAILED DESCRIPTION OF PREFERRED EMBODIMENTS

The present invention relates to a portable or fixed thermal remediation/treatment system and method which have the flexibility, depending on the contaminated media or oil-bearing media to be treated, to allow for the practice of low temperature thermal desorption, high temperature thermal desorption or pyrolysis. Any term or expression not expressly defined herein shall have its commonly accepted definition understood by those skilled in the art.

As will be apparent to those skilled in the art, various modifications, adaptations and variations of the foregoing specific disclosure can be made without departing from the scope of the invention claimed herein. The various features and elements of the described invention may be combined in a manner different from the combinations described or claimed herein, without departing from the scope of the invention.

The hydrocarbon bearing media may comprise any solid material which bears or is mixed with a hydrocarbon or mixture of hydrocarbons. The hydrocarbon may comprise any light or heavy oil, or a hydrocarbon residue resulting from another process. Typical hydrocarbon bearing media which may be treated with embodiments of the present invention include, without limitation, oil-contaminated soil, oil shale, oil sands, coal, bitumen, and oil-bearing sludges of different types from oil producers, upgraders or refineries. Media to be treated with high moisture content is also tolerated, however, in one embodiment, moisture content is preferably below about 20%.

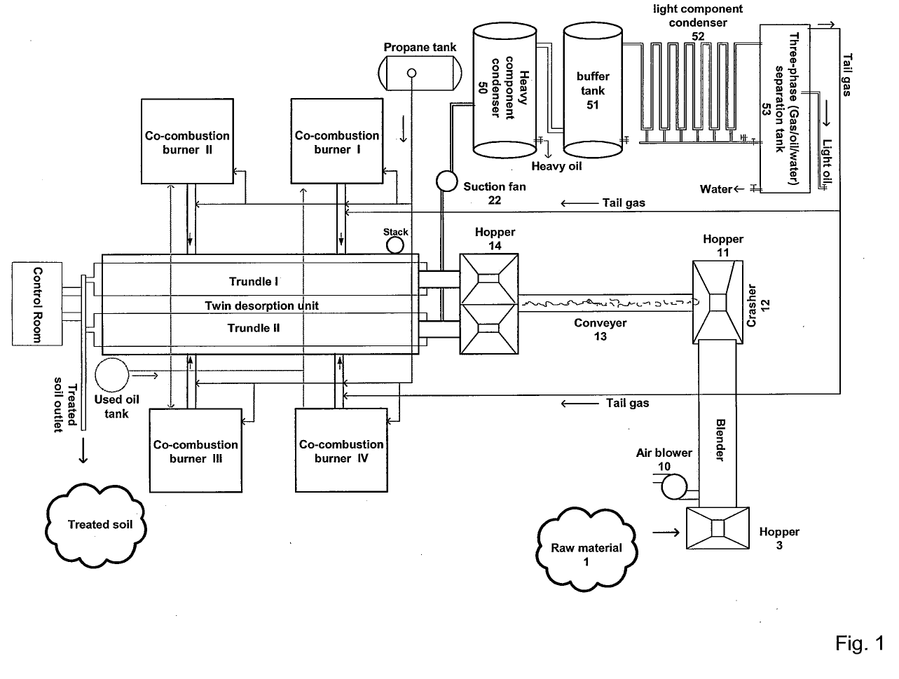

Exemplary embodiments of the present invention are described below with reference to the Figures. FIG. 1 shows a schematic overview of one embodiment of a process and system of the present invention, comprising a feed mechanism, a thermal desorption unit, a co-combustion burner to supply heat to the thermal desorption unit, and a condensing system. In the embodiment shown, a number of desorption units may be provided, with multiple desorption units allowing greater throughput through the system. In the embodiment shown, the desorption unit comprises twin trundles, and is heated by four co-combustion burners in order to volatilize heavy and light oils present in the hydrocarbon bearing media as it passes through the twin desorption unit. As used herein, the term “twin desorption unit” means a thermal desorption unit comprising two substantially identical trundles.

The volatilized heavy and light oils are withdrawn from the twin desorption units using a suction fan and then condensed separately in a heavy component condenser followed by a light component condenser. The condensed light oils are separated from water in a three-phase (gas/oil/water) separation tank.

The raw material is fed into the trundles using a blender with air blowing capability to break down big lumps and reduce moisture, and a hammer crasher to break down the big rocks so that the material can be fed smoothly into the desorption unit. The material after treatment are discharged from the twin desorption unit.

The co-combustion burner is adapted to burn different types of fuels individually or in any combination. Suitable fuels include gases (butane, propane, or natural gas), liquids (natural gas liquids, condensates or used or waste oils) and solids (coke, asphaltenes, coal or scrap tires), sludges with high oil content or combinations thereof. The fuels may be loaded intermittently or continuously. In one embodiment, solid fuels are loaded intermittently, while the gas, liquid and sludge fuels are loaded continuously from respective storage tanks. The burner may also utilize tail gas which is not condensed during condensation and recovery of the hydrocarbon vapor produced from the desorption unit.

In one embodiment, the system is powered and controlled using conventional electrical controls for systems of this nature, which are well known to those skilled in the art. The system may comprises an electrical control room includes all electrical panels and controllers attached to or detached from the twin desorption unit and other elements of the system.

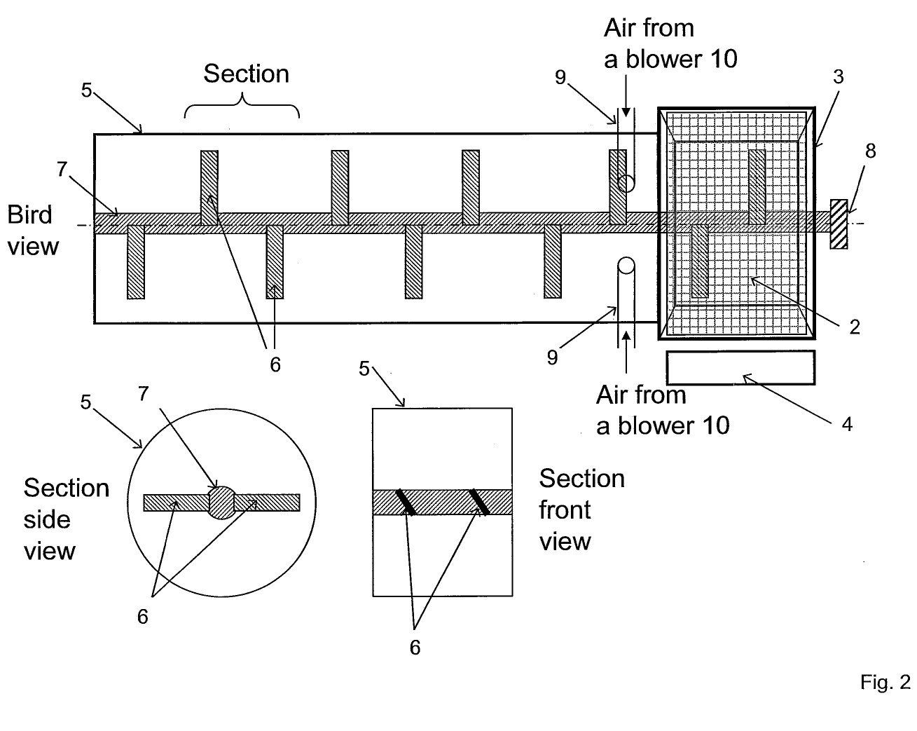

FIG. 2 shows a schematic drawing of one embodiment of a blender used to process the raw feed material 1. In one embodiment, the raw feed material 1 is metered using a loader equipped with a hydraulic metering system and deposited on a static screen 2 after which the raw feed material enters a feed hopper 3. The feed hopper 3 may comprise a funnel flow type bin. The angle of the static screen 2 may be adjusted, for example from between 0 to 60 degrees in order to discharge oversized material or debris (generally 10 cm and larger) into a collection bin 4. From the feed hopper 3, the feed material 1 is blended in the blender, where the material 1 is moved forward in a tube enclosure 5 by multiple paddles 6 attached to a rotating blender axis 7. The paddles 6 are gear 8 driven by a reversible variable speed motor. There are multiple air inlets 9 in the blender to receive air from an air blower 10 which serve to reduce moisture in the feed material. As shown in FIG. 1, the feed material 1 which has been reduced in average size by the action of the blender is then discharged to a hopper 11 attached to a hammer crasher 12 with a conveyer belt 13. The material is then discharged evenly to a feed hopper. In the embodiment illustrated, twin feed hoppers 11 and 14 are provided, and each may comprise funnel flow type bins.

The feed hoppers convey material to the desorption unit, which is designed to convey, turn, mix, and indirectly heat the material during processing. Preferably, in one embodiment, the desorption unit is self-cleaning.

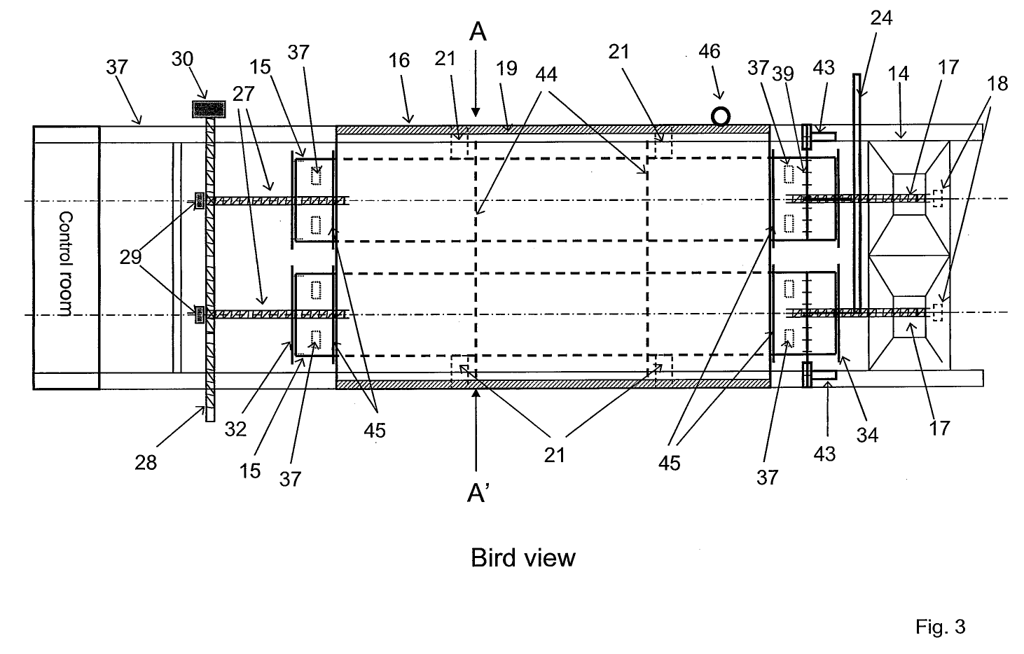

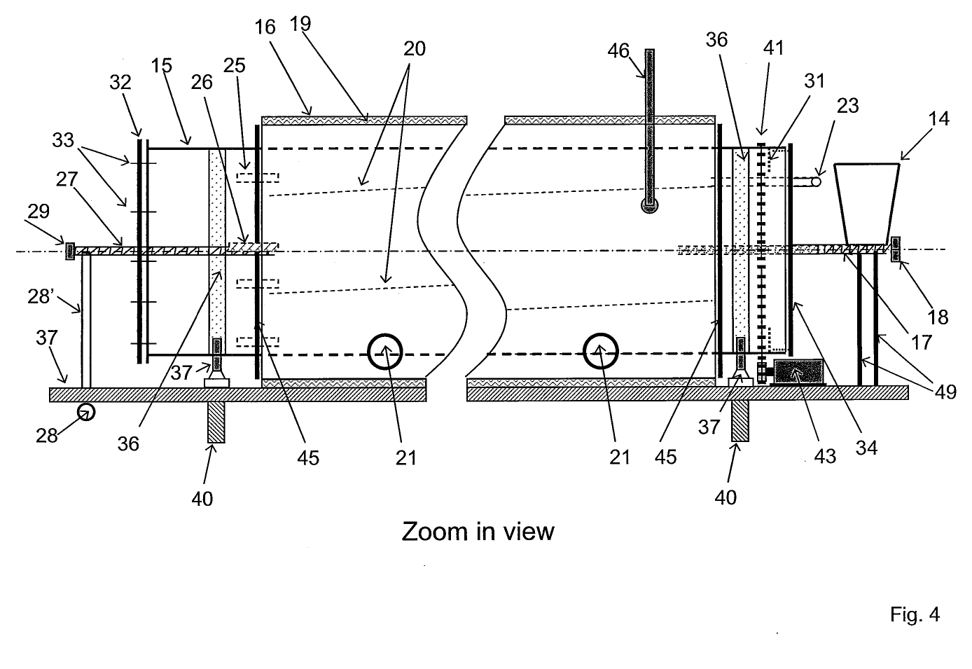

One embodiment of a twin desorption unit is shown in FIGS. 3 and 4. The desorption unit receives feed material 1 from the hopper 14 by means of a pair of augers 17 driven by a pair of gears 18 hooked with a reversible variable speed motor. The feed material is moved into the two rotating trundles 15 disposed within a stationary housing 16. The stationary housing 16 is insulated using fire proof insulation 19 such as fiberglass and/or mineral wool. The material is trundled from one end to another end while rotating due to the inclined space bars 20 attached to the inner surface of each trundle. At the same time, heat is supplied via the multiple heat inlets 21 to heat the material up to about 600° C., depending on the type of material being treated. Both heavy and light oils which have boiling points below the effective temperature are volatilized into gas oils. Any moisture in the material is also converted to steam. The temperature in the trundles may be varied according to the known or estimated composition of the feed material.

Although the size of the trundle may be increased to allow greater capacity, the rate of heat transfer into the trundle is adversely affected. As the diameter of the trundle increases, the ratio of surface area to volume decreases. Also, as the size of the trundle increases, the trundle must be made of thicker material to maintain adequate strength, which also adversely affects heat transfer.

As used herein, a “trundle” means a rotating cylinder or drum, where material contained within the trundle is advanced through the trundle by rotation of the trundle. Material may be advanced by inclination of the trundle, or by mechanical means such as internal paddles, fins or bars. In one embodiment, each rotating trundle each comprises multiple space bars attached to the inner surface of the trundle, the space bars are 1-3 inches high and approximately 1-1.5 feet apart and deviate from the axis of rotation by an inclination ratio of about (0-2):100.

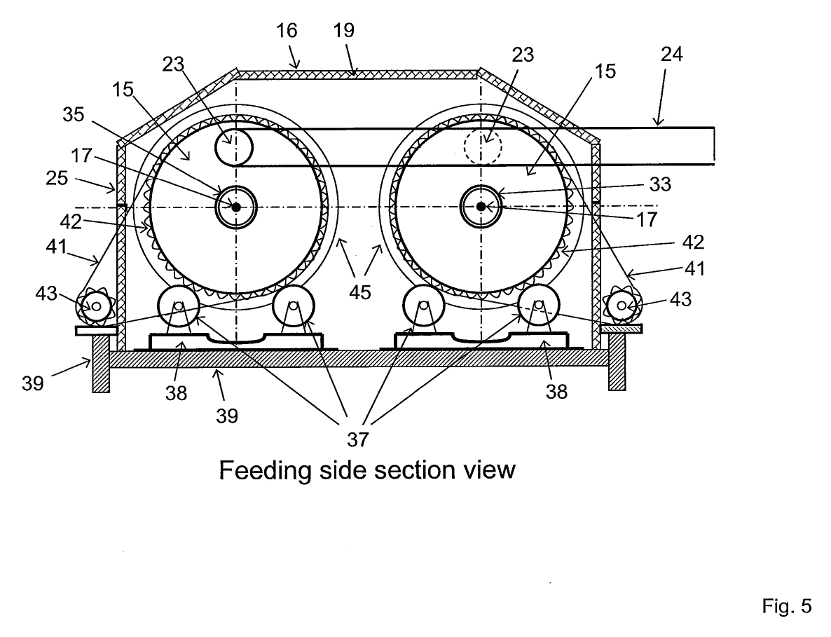

The volatilized gas oils and steam are withdrawn from each trundle through vapor outlets 23 with a suction fan 22 connected with a suction pipe 24, as shown in FIGS. 3 and 5. At the distal end of the desorption unit, the feed material remaining after thermal processing is scooped by scoops 25 attached to the inner surface of the trundles and then discharged to a pair of receivers 26. The material is then moved out of the trundles 15 by a pair of augers 27 and merged into another discharging auger 28 via a pair of pipes 28′. Both augers 27 and 28 are driven by reversible variable speed motors via gears 29 and 30.

As a result of the suction fan 22, the atmosphere in the trundle operates under a pressure slightly lower than atmospheric. This is advantageous in that it eliminates the need to seal the trundle, and to seal the housing it is contained in. The risk of leaking flammable or explosive gases is minimized as all hydrocarbon gases are sucked into the condensing system. The amount of vacuum pressure in the trundles and the housing may be varied by varying the speed of the suction fan 22.

A stop rim 31, shown in FIG. 4 is attached to the inner surface of the proximal end of the trundle in order to block material 1 going out of the trundle 15 while rotating the trundle. A cover 32 is provided at each end of the two trundles 15. The cover 32 at the distal end (processed material discharge end) is fixed to the trundle, for example, by multiple bolts 33, which permits removal of the cover when trouble shooting and maintenance. A cover 34 at the proximal feed hopper 14 end is attached to both the vapor outlets 23 and the feeding auger enclosure 35, as shown in FIGS. 4 and 5.

In order to improve the durability of the trundles 15, two strength rims 36 may be attached to the external surface of each trundle at the locations where the wheels 37 contact the trundle. Each two of the wheels 37 are mounted on a wheel holder 38 in a fixed distance apart, the wheel holder is then mounted on the frame structure 39 supported by multiple legs 40 and its mounting location on the frame structure 39 is adjustable slightly for easy positioning of the trundles 15. The trundle is preferably maintained in a horizontal position to allow adequate support along the length of the trundle by the wheels, and to prevent gravity creep of the trundle off its supports.

The trundles 15 may be rotated by any suitable means, for example a chain drive mechanism. At the feeding hopper 14 side, each trundle 15 is rotated by a chain 41 which links one side to a sprocket 42 attached to the trundle, and another side to a reversible variable speed motor 43 shown in FIG. 5.

The trundles are heated with hot exhaust from the co-combustion burners described below. To improve heat exchange, with reference to FIGS. 3, 4 and 6, there are two heat spacers 44 beside the heat inlets 21, inside the stationary house 16 and beneath the rotating trundles 15, dividing the stationary house 16 into three heating zones. The heat spacers do not completely segregate the heating zones, but do serve to restrict flow of the heating gases from one zone to the next. As a result, heat is supplied in a countercurrent fashion, with the hottest zone closest to the distal end of the trundle. In one embodiment, a heat stop rim 45 is attached to each side of the trundle shown in FIGS. 3 and 4. The residual heat and products of combustion exhaust from the desorption unit are discharged to the atmosphere via an exhaust stack 46, which preferably is high enough to reach local environment code.

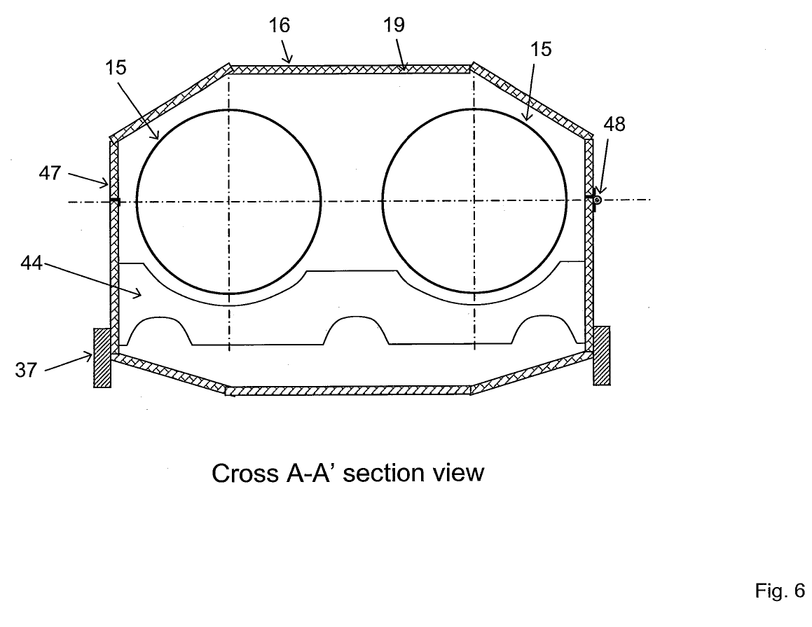

As shown in FIG. 6, the stationary house preferably provides means to access the trundles to repair or maintain the trundles. In one embodiment, the access comprises a hood 47 with hinges 48 hooked at one side so that the hood can be opened. As shown in FIG. 5, the cover 34, the vapor outlets 23 and the feeding auger enclosure 35 as well as the feeding hopper 14 are supported by a support frame structure 49.

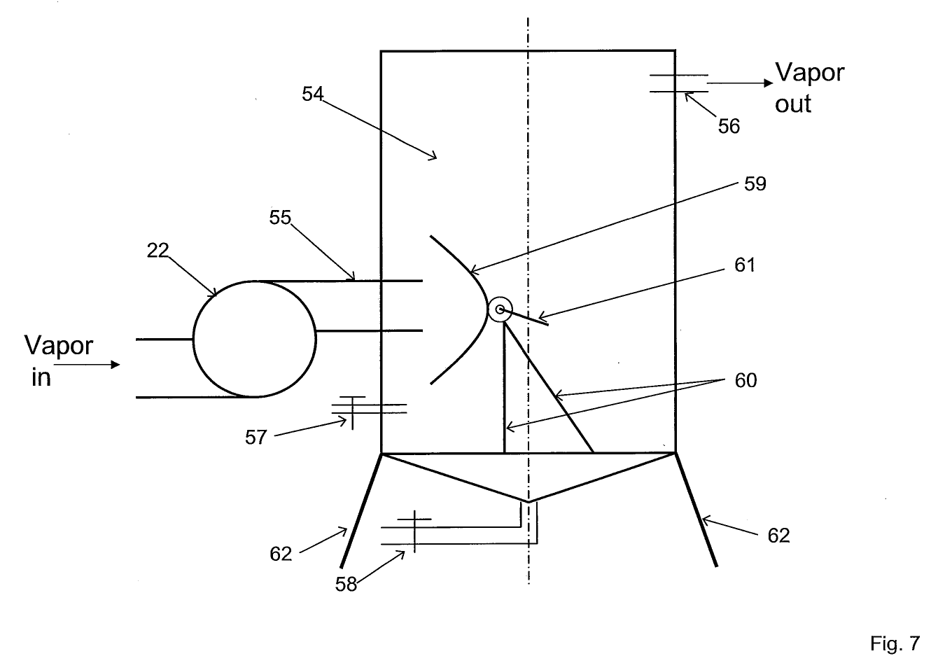

Both heavy and light components are volatilized into gas oils along with steam in the twin desorption unit. After being withdrawn by a suction fan 22, the volatilized gas oils and steam enter into a cooling line with a heavy component condenser 50 followed by a buffer tank 51, a light component condenser 52 and a three-phase separation tank 53. As shown in FIG. 7, the heavy component condensor 50 receives the volatilized components through a vapor inlet 55, a vapor outlet 56, an oil outlet 57, an oily sludge outlet 58 at the bottom, and condensing dish 59 which intercepts the gas flow. The condensing dish 59 comprises a cone-shaped or parabola-shaped impingement dish mounted on a dish holder 60 inside the cooling tank 54. Preferably, the condensing dish is adjustable with a handle 61. The condensor 50 may have a cone-shaped bottom to facilitate collection and removal of heavy condensate, and rests on multiple legs 62. Both oil and oily sludge need to be discharged intermittently via the oil outlet 57 and the oily sludge outlet 58, respectively.

The incoming stream of gas oils is aimed at the condensing dish at relatively high velocity. Heavy gas oils are condensed on the surface of the condensing dish 59 at a high impingement pressure created by the velocity of the incoming gas stream. Uncondensed light gas oils and steam will leave via the vapor outlet 56 for the light component condenser 52 for further condensation. The impingement pressure may be varied by tilting the dish at an angle, or moving it farther away from the vapor outlet. The ratio (measured by mass or volume) of the heavy components condensed to uncondensed light components in the heavy component condenser 50 can be changed significantly by adjusting the impingement angle of the condensing dish 59 using the handle 61, which will alter the impingement pressure created at the surface of the condensing dish. Alternatively, or additionally, the impingement pressure can be varied by moving the condensing dish 59 closer to or farther away from the incoming gas stream. The dish position can be adjusted by moving the dish holder 60 closer to or far from the vapor inlet 55. As may be appreciated by one skilled in the art, higher pressure is conducive to condensation of lighter components.

The heavy to light condensation ratio in the heavy component condenser 50 also changes when the operating temperature of the twin desorption unit changes. This means that the so called “heavy” or “light” is a relative concept, which is different from the conventional concept of heavy oil or light oil. Conventional heavy crude oil is any type of crude oil which does not flow easily. It is referred to as “heavy” because its density or specific gravity is higher than of light crude oil. Heavy crude oil has been defined as any liquid petroleum with an API gravity less than 20°, meaning that its specific gravity is greater than 0.933. Light oils and even water can be condensed in the heavy component condenser 50, especially, when the whole system starts or restarts and the twin desorption unit and the condensing elements have not yet reached their operating temperatures. Steam should not be condensed in the heavy component condenser 50 once its internal temperature reaches above about 110° C.

From the condensor 50, in one embodiment, the vapor stream continues to the buffer tank 51, provides additional volume for the volatilized vapors to avoid abrupt pressure fluctuation in the cooling line. The buffer tank 51 may not be necessary if the heavy condensor 50 is of sufficient volume relative to the flow rate of the system. Some minimal condensation of medium weight hydrocarbons may occur in the buffer tank 51 and a liquids outlet is provided.

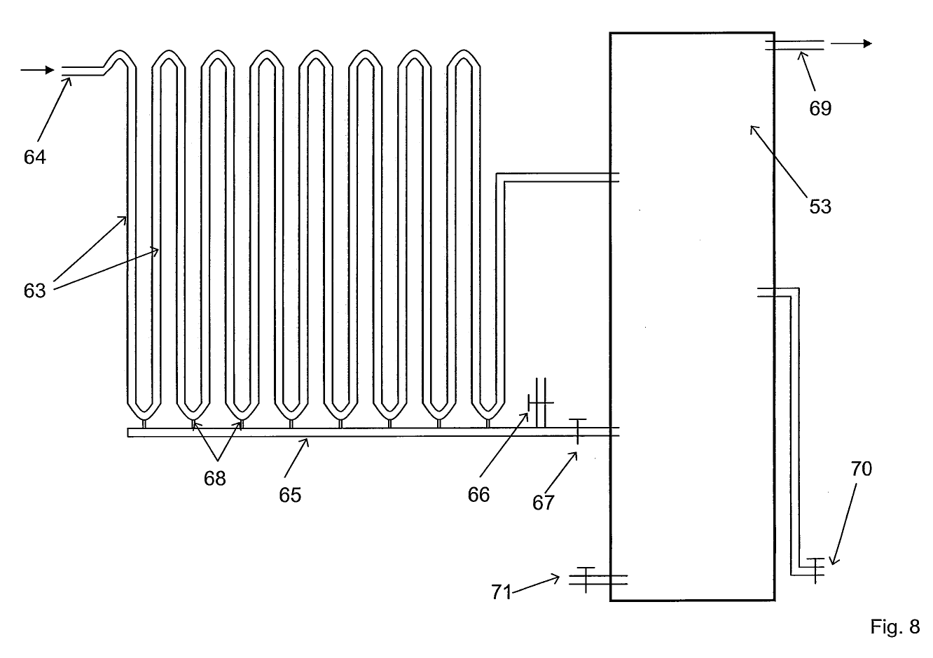

As shown in FIG. 8, a light component condenser 52 receives the vapor phase from the heavy component condenser via the buffer tank 51, and discharges both liquid and gas phases into the three-phase (gas/oil/water) separation tank 53. In one embodiment, the light component condenser comprises a set of air cooling pipes 63 vertically (or sufficiently inclined to collect condensate by gravity) arranged to condense light gas oils and steam received via the vapor inlet 64. A substantially horizontal collection pipe 65 collects condensate from the cooling pipes 63 and drains into the separation tank 53. In one embodiment, the collection pipe comprises two valves 66 & 67. One of the two valves is a try valve 66 with open to the atmosphere and another is an inline valve 67 to control flow into the three phase separator 53.

Light gas oils and steam are condensed in the vertical or inclined pipes 63 and flow down to the collection pipe 65, then to the three-phase separator 53. The try valve 66 may be used to visually check the performance of the condenser. The extent of the inline valve 67 opening may depend on the system operating temperature and the cooling performance of the light component condenser 52. The inline valve 67 should be open to the extent that no significant amount of liquid comes out of the try valve 66 when the try valve 66 is open. As a result, uncondensed vapor will go to the three-phase separator 53 primarily via the cooling pipe, while substantially all of the condensate will enter the three-phase separator (53) via the horizontal collection pipe.

The three-phase separator 53 receives uncondensed vapors from the end of cooling pipe 63 at the upper part, and liquid from the horizontal pipe 65 at the lower part. With sufficient residence time in the tank, gases dissolved in the liquid phase will be released and liquid hydrocarbons will separate from water. The remaining vapor or tail gas may be flared off, or may be recycled back to the co-combustion burners, through vapor outlet 69. Light oil and water are released intermittently via oil outlet 70 and water outlet 71, respectively.

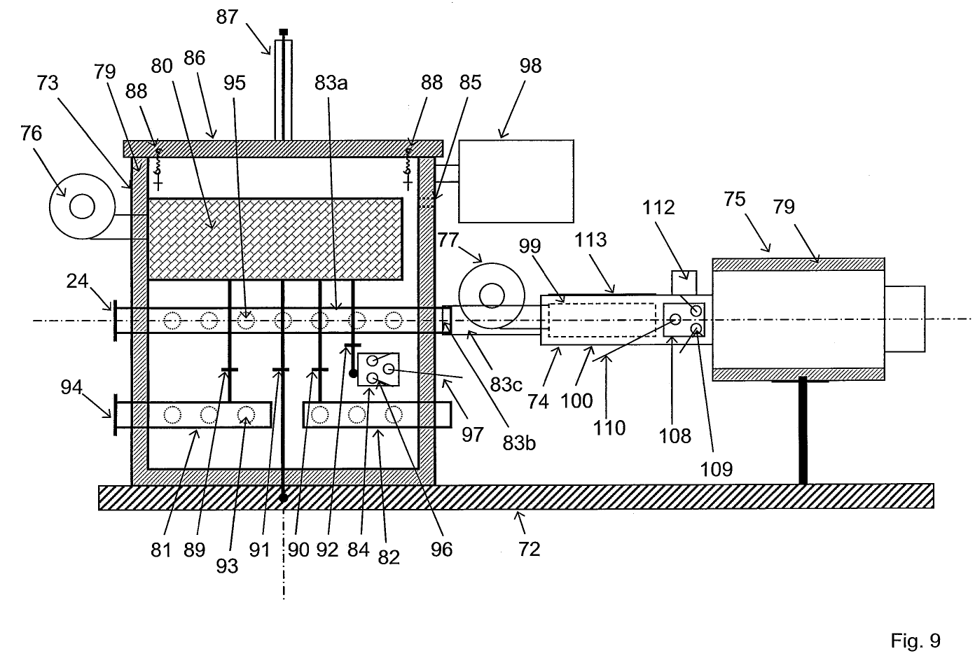

The present invention comprises a high efficiency co-combustion burner that supplies heat to the desorption unit. As shown in FIG. 9, the co-combustion burner is built on a frame structure 72 and comprises a burner box 73, a turbo chamber 74, a combustion chamber 75 and two air blowers 76 and 77. The co-combustion burner can be used alone as a heat energy generator to supply heat for any other applications, such as for a boiler.

In the burner box 73, part or all of the volatiles and semi-volatiles of liquid fuels such as used or waste oils, solid fuels such as coal, coke or scrap tires and sludge fuels (sludges with high oil content) are converted into gas oils 78 (or smoke). The turbo chamber 74 creates a turbulent flow and mixes thoroughly the volatilized gas oils and additional air provided by the blower 77, and streams the mixture to the combustion chamber 75. Both the burner box 73 and the combustion chamber 75 are preferably insulated using high temperature insulation 79 such as cement mix or mineral wool.

A suitable fuel is introduced to the burner box 73 through inlet 85 located at the upper part and front side of the burner box. In reference to the Figures, the front side of the burner box is that side which faces the combustion chamber 74. The burner box 73 comprises a lid 86 with hinges hooked at one side so that the lid 86 can be opened when loading solids fuels and to perform maintenance. The lid may comprise a burner lid opener 87 to open the lid, and multiple spring latches 88 to hold the lid closed. The spring latches may act as a pressure relief mechanism as they may be designed to release if pressure within the burner box reaches an unsafe level. In one embodiment, liquid or solid fuels may be automatically metered into the burner box.

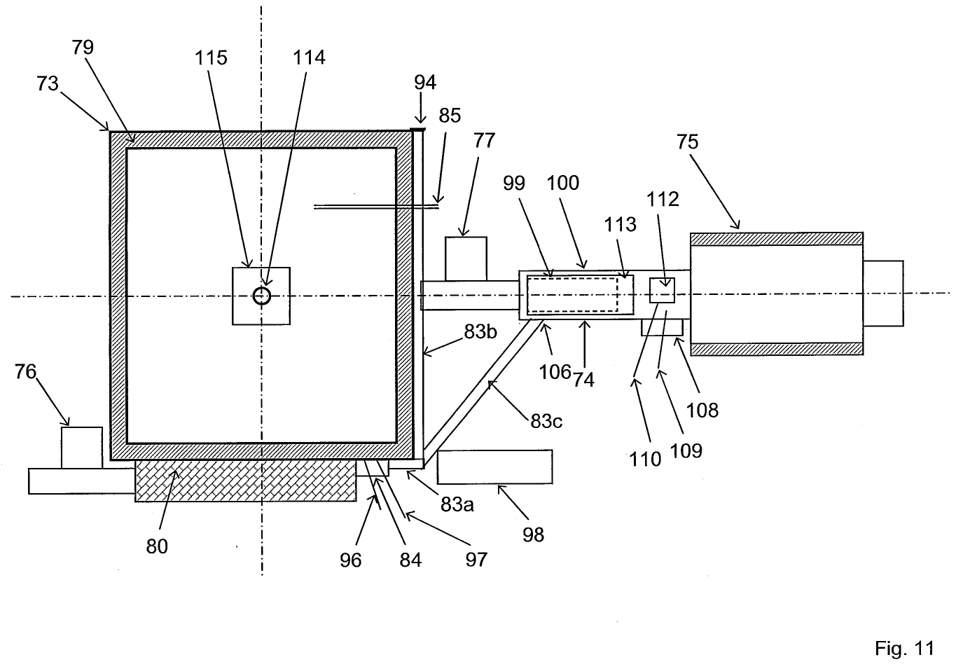

As shown in FIGS. 9 and 11, the burner box 73 comprises an air distribution box 80 attached to one side of the burner box 73 and gas oil collection channels 83a, 83b attached to at least one side of the box at approximately a mid-height level. In one embodiment, the air distribution box feeds at least two air distribution channels. A first air distribution channel 81 is centrally disposed in a lower location, and a second channel 82 is disposed around three sides (left, front and right) of the burner box. The two gas oil collection channels 83a, 83b merge into one channel 83c which leads to the turbo chamber 74.

The air distribution box 80 receives air provided by the air blower 76 and is connected to the two air distribution channels: one air supply line 89 to the left-sided distribution channel 81 and one 90 to the three-sided (left, front and right) air distribution channels 82. In addition, in one embodiment, the air distribution box provides a separate air supply 91 to the bottom of the burner box at a central location, and another air supply 92 to the burner box directly right beside the igniter box 84. The air distribution channels 81 and 82 comprise multiple holes 93 to the inside of burner box 73 and a cover 94 for each air distribution channel so that the channels can be opened for the channel cleaning.

The centre bottom air supply 91 provides additional oxygen to promote more complete combustion and ashing of the fuels in the ash chamber. The igniter box air supply 92 provides sufficient oxygen to support ignition when required. Each of the air supply lines 89, 90, 91, 92 may comprise adjustable valves which permit rebalancing the air supply throughout the burner box.

Air is distributed to the burner box through the multiple holes 93 and the volatilized gas oils 78 are withdrawn from the burner box to the gas oil channel 83 through the multiple holes 95. There is also a cover 24 similar to the cover 94 at the end of the gas oil exiting channels 83a and 83b for channel cleaning maintenance.

The specific configuration of air distribution holes and channels, as well as the gas oil outlet holes and channels illustrated in the Figures is not essential to the claimed invention. The introduction of air and withdrawal of gas oils may be designed to promote the processes which occur in the burner box. The air holes 93 are preferably positioned below the gas oil holes 95.

The igniter box 84 is disposed within the burner box 73 and comprises an igniter probe 96 and a gas (preferably propane or natural gas) nozzle 97. The igniter probes 96 are wired to a transformer in the electrical panel 98 and make sparks to light the gas (propane or natural gas). Alternatively, a plasma igniter or a conventional pilot light may be used to provide ignition in the burner box.

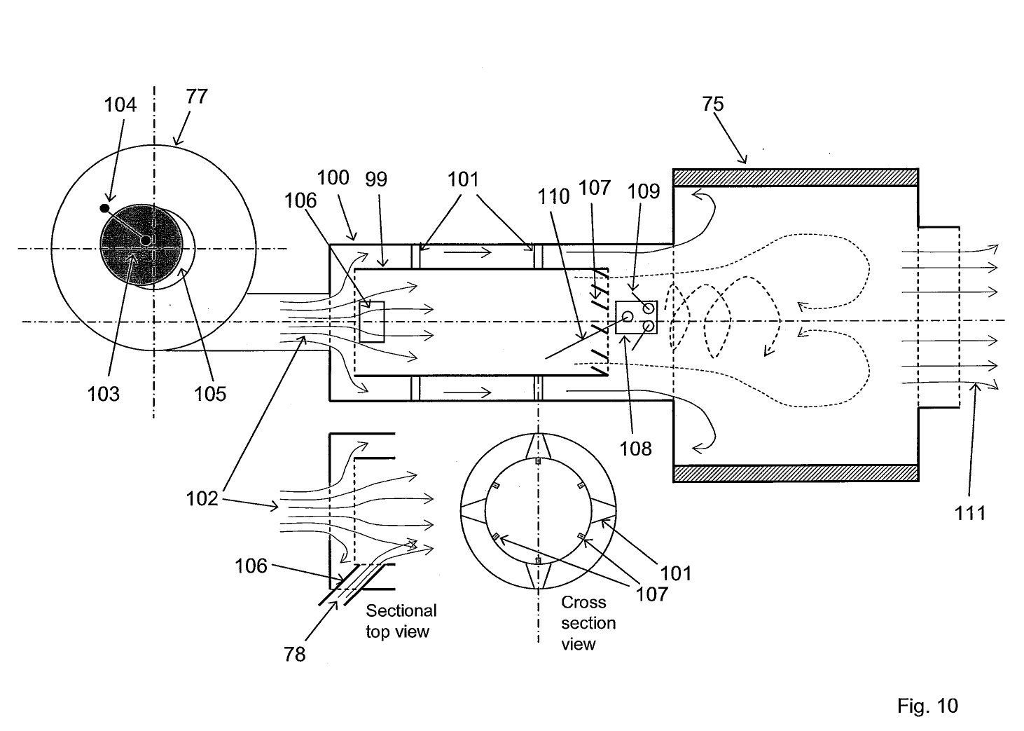

As shown in FIG. 10, the turbo chamber 74 comprises an internal and an external tubes 99 and 100 concentrically disposed and separated by centralizers 101. In one embodiment, the ratio of diameter between the internal and external tubes may vary from about 2:3 to about 3:4. An air entrance receives air 102 from the air blower 77 with a door 103 and a door handle 104 to control the flow rate of the air flowing into the air inlet 105, an gas oil inlet 106 connected with the gas oil channel 83c to receive gas oils 78 from the burner box 73. The combined gas oils and air exit to the combustion chamber 75. Air flows through the annular space between the internal 99 and external tubes 100 and also flows into the combustion chamber.

The internal tube 99 comprises multiple fins 107 located at the exit side to enhance turbulent flow of the gas mixture, which assists in more thorough combustion in the combustion chamber 75. The combined flow into combustion chamber has the gas oils concentrated in a central portion, while the outer flow is predominantly air. The flow is turbulent, resulting in thorough mixing of the fuel gases and air, which provides thorough combustion.

Similar to the igniter box 84 attached to the burner box 73, the igniter box 108, as shown in FIGS. 9 and 10, comprising a pair of igniter probes 109 and a gas (propane or natural gas) nozzle 110, is used to ignite the gas oil/air mixture. A reliable source of ignition is required in the combustion chamber, so that all gas oils 78 will be burned to produce heat (and its products of combustion) 111 for the twin desorption unit.

In one embodiment, as shown in FIG. 9, there is a flame view window 112 for an operator to check flame status and a turbo window cover 113 for operator to clean the gap between the internal and external tubes 99 and 100. More details of the burner box 77, turbo and combustion chambers 74 and 75, ignition boxes along with the configuration of the gas oil (smoke) channels in the middle of the left and front sides can be observed in FIG. 11, which shows a bird view of the co-combustion burner.

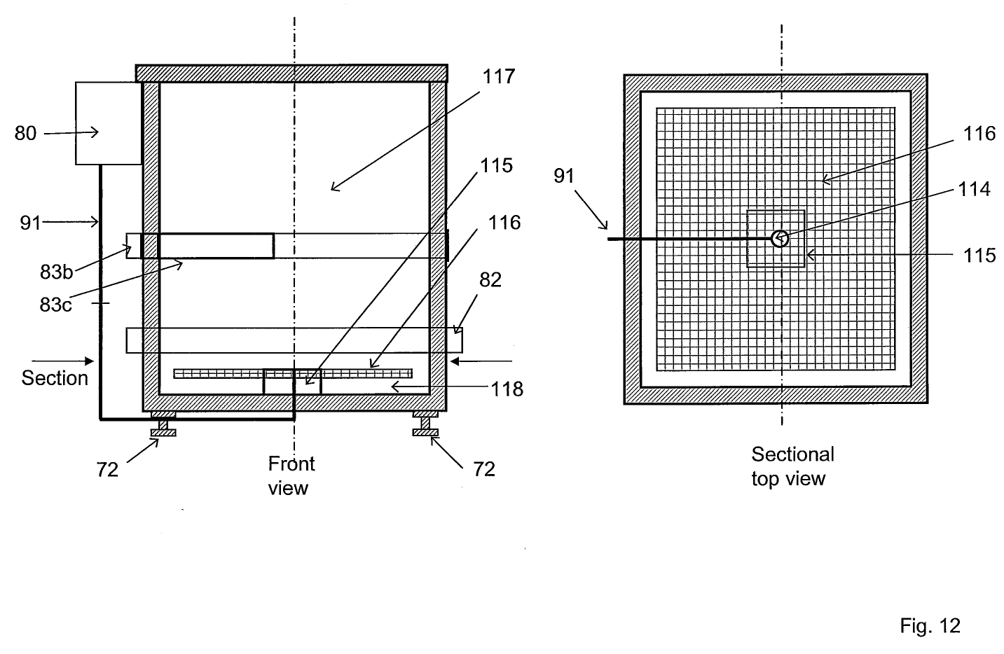

As may be seen in FIG. 12, the air supply line 91 is preferably routed to the bottom center of the burner box through an air supply hole 114 centered in a supporting concrete center base 115. A movable screen 116 divides the burner box into a volatilizing portion 117 at the top and an ash portion 118 at the bottom to collect ash. The screen 116 is supported by the concrete center base 115.

The burner box 73 is primarily a fuel gasification unit. A wide variety of fuels may be volatilized into gas oils at a temperature not greater than 700° C. For example, it is known that an operating temperature of 200° C. is required to volatilize tires, and 400° C. is required to volatilize coals. The resulting gas oils are then burned thoroughly in the combustion chamber 75. This volatilizing process in the burner box is a combination of pyrolysis, gasification, cracking, vaporization and carbonization.

In the burner box, after all volatiles are volatilized, the residues need a higher temperature to burn into ash. However, it does not mean that the volatilizing room 117 has to be operated at an average temperature higher than 700° C. for ashing the residues, because ashing is in progress any time on surface of the fuels where localized temperatures could be more than 1000° C. The fuel is volatilized, and not burned, as a result of restricting oxygen supply to the burner box. Accordingly, the air flow rate in each air supply line 89, 90, 91 and 92 is controlled such that less than a stoichiometric combustion amount of air is supplied to the burner box 73.

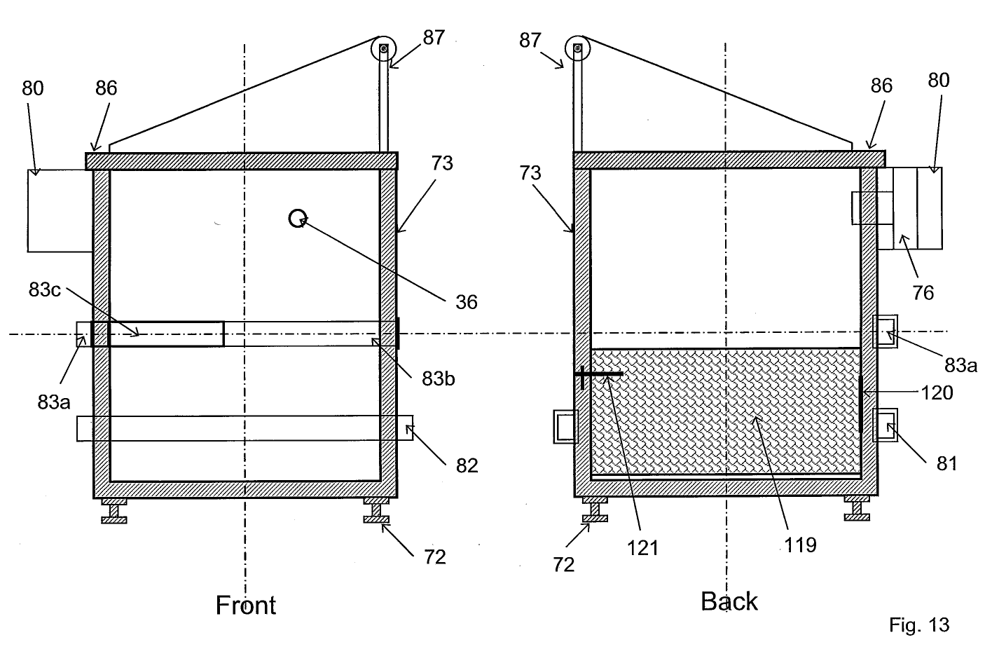

The ash in the ash room 118 is removed or cleaned intermittently through a door 119 with hinges 120 and a door hook 121 hooked at the back side of the burner box 73 as shown in FIG. 13.

As shown in FIGS. 9, 10 and 11, in one embodiment, both the combustion chamber and the turbo chamber are cylindrical, with the combustion chamber 75 being larger than the turbo chamber 74 in diameter. In one embodiment, the diameter ratio may be in the range of about 1.5:1.0 to about 4.0:1.0. The combustion chamber preferably includes a narrowed exit for the heat and products of the combustion 107 to exit, which results in the exhaust velocity of the combustion products to be quite high. The combustion chamber is insulated using a fire proof refractory material, which in one embodiment should tolerate temperatures not less than 1500° C.

Liquid (used oil) or sludge (sludge with high oil content) fuel is supplied to each burner through the used oil inlet 85, and solid fuels (coal and/or scrap tires) are loaded intermittently into the volatilizing room 117 on the screen 116 after ash is removed. Alternatively, an automated fuel feeder may be provided. The gas (propane or natural gas) line from each co-combustion burner to a gas tank is connected with the gas (propane or natural gas) nozzles 97 and 110 on the two igniter boxes 84 and 108. Gas, liquid and sludge fuels are loaded continuously from the gas tank, used oil tank or sludge fuel tank, respectively.

In combination, the components the system described herein provides a process and system capable of remediating highly contaminated materials, making it suitable for a variety of applications. Applications include treatment of invert drill muds, residual tank bottoms, and contaminated soils. Combined with the operating flexibility of the unit, the process is capable of treating materials contaminated with both organic and inorganic constituents. The system may have application in the remediation of materials contaminated with contaminates such as non-halogenated and halogenated volatile and semi-volatile organics, fuels, and inorganics. These types of contaminates are associated with industrial wastes derived from agricultural, chemical processing, petroleum producing and refining, reuse processing, paint and ink manufacturing, plastics manufacturing and pharmaceutical manufacturing industries.

In one embodiment, the system may be configured to operate separately as low temperature thermal desorption, high temperature thermal desorption and pyrolysis systems or in series or as any combinations thereof.

In one embodiment, the system may be used in a method for producing oil from oil shale, oil sands, coal and any oil-bearing media without using water as extraction solvent. In these applications, solid feed stocks can be directly fed into the crasher, omitting the blender in the feeding line.

The process is easily adaptable to a wide range of operating parameters to control retention time, system operating pressure, operating temperature, and capacity to satisfy the end process treatment criteria for varying feedstock materials.

1. A thermal remediation or oil production system for treating hydrocarbon bearing media, comprising:
(a) a thermal desorption unit comprising:
(i) a housing;
(ii) at least one rotating trundle disposed within the housing;
(iii) at least one divider dividing the desorption unit into two or more temperature zones along its length such that the temperature of each temperature zone can be heated to temperatures sufficient to volatilize at least a portion of one or more of the hydrocarbons;
(iv) a feed line to feed the hydrocarbon bearing media into the at least one trundle;
(v) a suction fan to pull out volatilized hydrocarbons and create a slightly vacuum environment in the at least one trundle;
(vi) a solids discharge outlet for discharging treated solid media from the at least one trundle;
(b) at least one burner operatively connected to the desorption unit to supply hot exhaust gas within the housing; and
(c) a condenser for condensing at least a portion of volatilized hydrocarbons pulled out of the at least one trundle.

2. The system of claim 1 wherein the thermal desorption unit comprises at least two trundles.

3. The system of claim 2 wherein the desorption unit comprises two dividers, creating three temperatures zones.

4. The system of claim 1 comprising at least two burners, which comprise co-combustion burners.

5. The system of claim 1 wherein the condenser comprises a heavy component condenser, a light component condenser, and a three phase separator.

6. The system of claim 1 wherein the heavy component condenser comprises gas inlet line and a condensing bowl, wherein the gas inlet line is aimed at the condensing bowl, and wherein gas velocity in the gas inlet line results in increased pressure at the surface of the condensing bowl.

7. The system of claim 6 wherein the light component condenser comprises a plurality of vertically oriented condensing pipes, wherein said condensing pipes are linked in a serpentine manner, and a collection pipe connected to a lower end of each condensing pipe.

8. The system of claim 6 wherein the three phase separator comprises an upper portion and lower portion, and wherein the light component condenser condensing pipe empties into an upper portion, and the collection pipe empties into the lower portion, and the separator comprises a tail gas outlet, a condensed hydrocarbon outlet, and a water/solids outlet.

9. The system of claim 5, wherein each trundle is rotatably mounted on a base comprising a frame structure and a plurality of wheels.

10. The system of claim 1, wherein heat flow in the housing is countercurrent to material flow in the trundle.

11. A thermal remediation or oil production system for treating hydrocarbon bearing media, comprising a thermal desorption unit, and at least one co-combustion burner for indirectly heating the media within the thermal desorption unit, wherein each co-combustion burner comprises:
(a) a burner box having a fuel inlet, an air inlet, a vaporization chamber, an igniter and a gas outlet for gas oils, wherein fuels are partially combusted in the burner box to create gas oils;
(b) a turbo chamber connected to the gas outlet of the burner box and comprising an external tube and an internal tube concentrically disposed within the external tube, wherein the gas outlet streams gas oils into the internal tube, and said turbo chamber comprises an air inlet feeding both the external tube and internal tube; and
(c) a combustion chamber which receives the gas oil air mixture from the turbo chamber, said combustion chamber having an igniter and a hot exhaust gas outlet.

12. A co-combustion burner comprising:
(a) a burner box having a fuel inlet, an air inlet, a vaporization chamber, an igniter and a gas outlet for gas oils, wherein fuels are partially combusted in the burner box to create gas oils;
(b) a turbo chamber connected to the gas outlet of the burner box and comprising an external tube and an internal tube concentrically disposed within the external tube, wherein the gas outlet streams gas oils into the internal tube, and said turbo chamber comprises an air inlet feeding both the external tube and internal tube;
(c) a combustion chamber which receives the gas oil air mixture from the turbo chamber, said combustion chamber having an igniter and a hot exhaust gas outlet.

13. The co-combustion burner of claim 12, wherein the burner box comprises a volatilizing chamber and an ash chamber, divided by a movable screen.

14. The co-combustion burner of claim 13 wherein the burner further comprises an air distribution box attached to the burner box, and at least two air distribution channels to distribute air to lower locations in the burner box.

15. The co-combustion burner of claim 14, wherein the air distribution box supplies at least four air supply lines: first and second air supply lines to supply the at least two air distribution channels, a third air supply line to the bottom center of the burner box, and a fourth air supply line to the igniter box.

16. The co-combustion burner of claim 12, wherein the ratio of diameter of the internal tube to the external tube is about 2:3 to about 3:4.

17. The co-combustion burner of claim 12, wherein the internal tube comprises a plurality of fins located at the said exit side to enhance turbulent flow of the gas mixture as it enters the combustion chamber.

18. A condensing system for condensing a mixture of volatile hydrocarbons, said system comprising:
(a) a heavy component condenser comprises gas inlet line and a condensing bowl, wherein the gas inlet line is aimed at the condensing bowl, wherein gas velocity in the gas inlet line results in increased pressure at the surface of the condensing bowl.
(b) a light component condenser comprising a plurality of vertical or inclined condensing pipes, wherein said condensing pipes are linked in a serpentine manner, and a collection pipe connected to a lower end of each condensing pipe; and
(c) a three phase separator for receiving uncondensed gas from the condensing pipes, and condensate from the collection pipe, said three phase separator having an upper gas outlet, a middle oil outlet, and a lower water outlet.

19. The condensing system of claim 18 wherein an inclination angle of the condensing bowl is adjustable.

20. The condensing system of claim 18 wherein the position of the condensing bowl is adjustable to vary the distance of the condensing bowl from gas inlet line.
